(19) United States
(12) Patent Application Publication
(10) Pub. No.: US 2008/0035900 A1
(43) Pub. Date: Feb. 14, 2008

(54) Belt molding removal tool

(76) Inventor: Julio E. Flores, Antioch, CA (US)

Correspondence Address: LITMAN LAW OFFICES, LTD., P.O. BOX 15035, CRYSTAL CITY STATION, ARLINGTON, VA, 22215, US

(21) Appl. No.: 11/889,054

(22) Filed: Aug. 8, 2007

Related U.S. Application Data
(60) Provisional application No. 60/836,150, filed on Aug. 8, 2006.

(51) Int. Cl. B66F 15/00; B25B 27/14

(52) U.S. Cl. 254/21; 29/278

(57) ABSTRACT

The belt molding removal tool is a tool for removal of an automotive belt molding, window molding, and the like from a body panel and includes a hook formed on a free end of a rigid and sturdy shank. The opposite end of the shank has a substantially cylindrical palm grip provided for gripping the belt molding removal tool. The shank may be a straight shank, or may have complementary bends formed therein. The hook is formed from a relatively flat blade in order to provide sufficient purchase for pulling the molding from retainer clips while preventing damage to the molding.

### CROSS-REFERENCE TO RELATED APPLICATION

This application claims the benefit of U.S. Provisional Patent Application Ser. No. 60/836,150, filed Aug. 8, 2006.

### BACKGROUND OF THE INVENTION

1. Field of the Invention

The present invention relates to auto body repair tools, and more specifically to a belt molding removal tool.

2. Description of the Related Art

Auto body repair shops are frequently confronted with the task of repairing or painting damaged auto body panels. Belt molding affixed to the panel, usually by a belt molding clip, must be removed from the panel before the repair or painting operation is commenced. Oftentimes a technician may attempt to use a screwdriver to remove the belt molding. However, the use of a screwdriver for the belt molding removal process suffers from a number of disadvantages, including the risk of damaging the belt molding when it is removed from the panel in that manner. The problem remains that until now it has been very difficult to pry a belt molding from the retaining clips attached to a panel without destroying some portion of the belt molding.

Thus, a belt molding removal tool solving the aforementioned problems is desired.

### SUMMARY OF THE INVENTION

The belt molding removal tool is a tool for removal of an automotive belt molding, window molding, and the like, from a body panel and includes a formed hook on a free end of a rigid, sturdy shank. The other end of the shank has a substantially cylindrical palm grip provided for gripping the belt molding removal tool. The hook is relatively wide in order to obtain purchase on a length of the molding and avoid tearing the molding. The shank may be a straight shank, or the shank may have a bend or offset therein.

These and other features of the present invention will become readily apparent upon further review of the following specification and drawings.

### BRIEF DESCRIPTION OF THE DRAWINGS

FIG. 1 is an environmental, perspective view of a first embodiment of a belt molding removal tool according to the present invention.

FIG. 2 is a perspective view of the belt molding removal tool of FIG. 1.

FIG. 3 is an environmental, perspective view of an alternative embodiment of a belt molding removal tool according to the present invention.

FIG. 4 is a perspective view of the belt molding removal tool of FIG. 3.

Similar reference characters denote corresponding features consistently throughout the attached drawings.

### DETAILED DESCRIPTION OF THE PREFERRED EMBODIMENTS

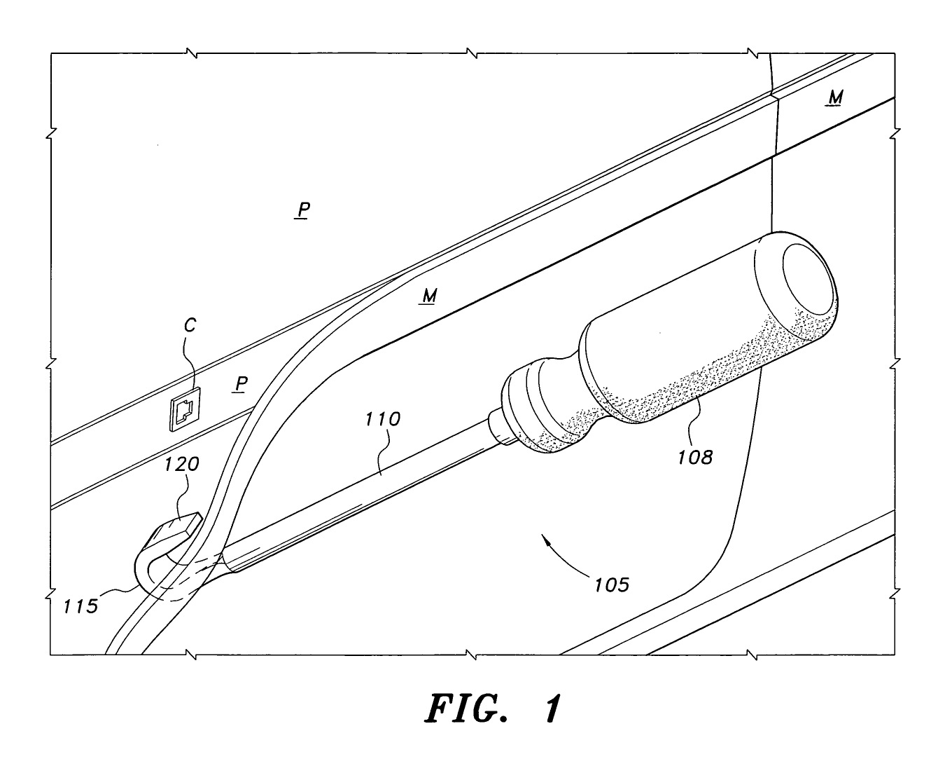

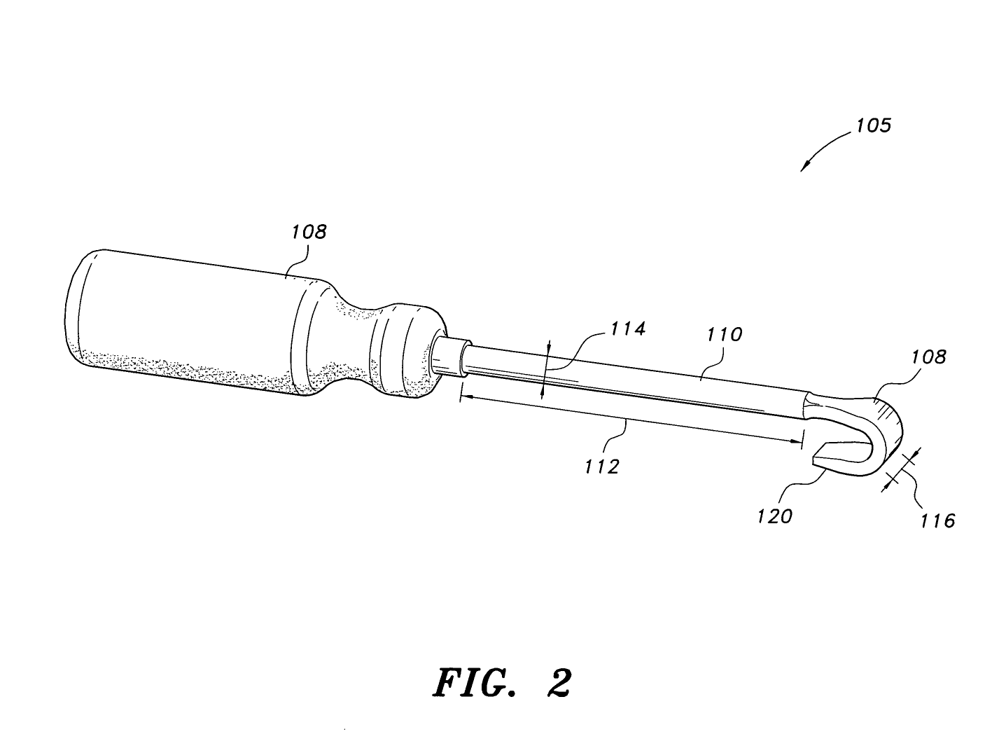

As shown in FIGS. 1-2, the present invention is a tool 105 for removal of an automotive belt molding M from a body panel P and includes a formed hook on a bottom end of a straight, rigid and sturdy shank 110 that is not elastically deformable. The top end of the shank 110 has a substantially cylindrical palm grip 108 provided for gripping the belt molding removal tool 105.

The shank 110 may be cylindrical, hexagonal, or any other shape. The longitudinal dimension of the shank 110 is substantially greater than its lateral dimension. The hook is formed by a bend 115 that creates a folded-over extension of the shank 110. The hook terminates in a wedge-shaped leading edge to form a blade 120 similar to a typical screwdriver blade. The blade lateral dimension 116 is preferably at least as wide as the shank lateral dimension 114, and is relatively wide, being between ¼″ and ¾ wide.

Preferably, the bight or bend 115 of the hook is substantially U-shaped, forming a 180° bend, so that the blade 120 is substantially parallel to the shank 110, thus causing the blade 120 to be aimed towards the handle 108. When the curved hook engages the belt molding M on a car door, a user who is gripping the palm grip 108 can pull on the belt molding M with the tool 105 to displace the belt molding M from a belt molding retaining clip C on a body panel P, thereby freeing the belt molding M from the body panel P. The curvature of the hook and the width of the hook prevent the belt molding from being damaged or broken during the removal process when using the belt molding removal tool 105. The belt molding removal tool 105 may also be used to restore misaligned door panels by unbending the door panels.

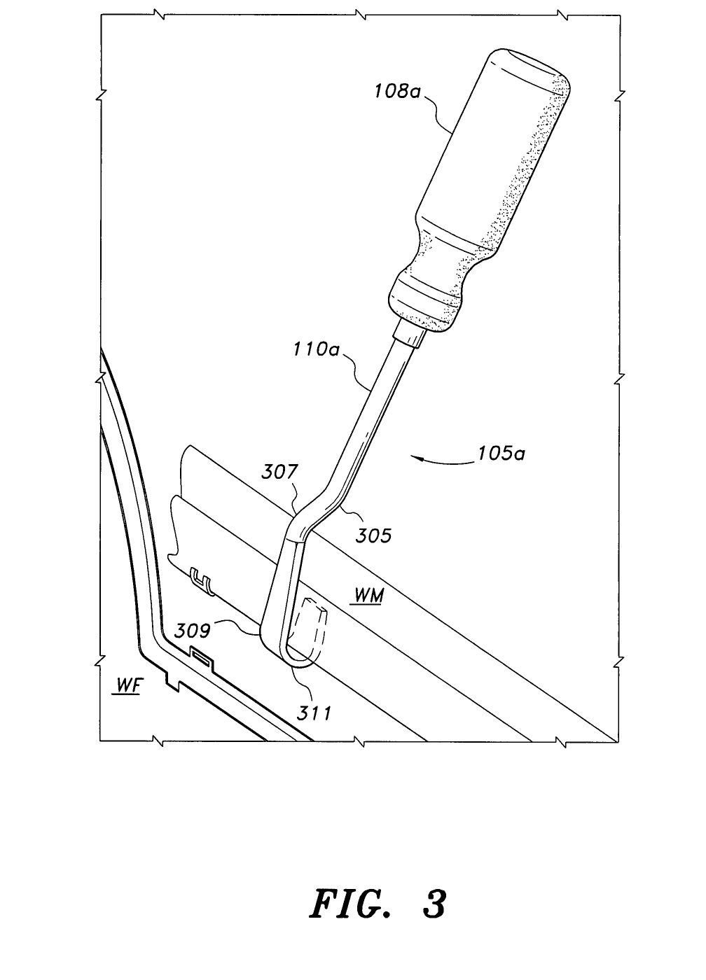

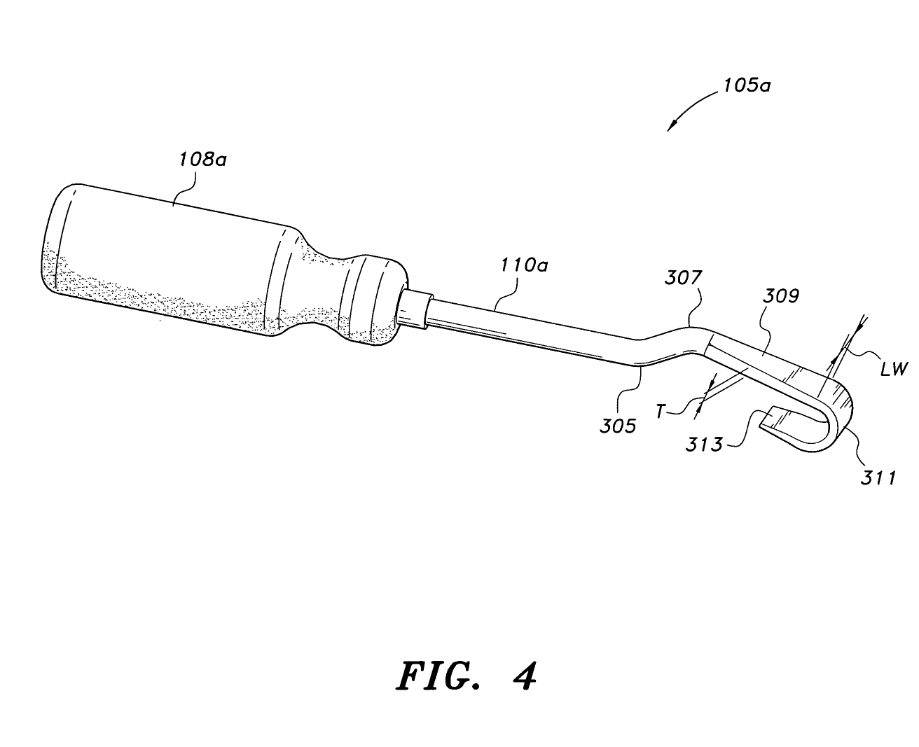

As shown in FIGS. 3-4, an alternative embodiment of a belt molding removal tool 105a is disclosed to have a first bend 305 of a shank 110a at a first predetermined distance from handle 108a. A second bend 307 of the shank 110a is of opposite direction from the first bend 305 and is disposed a second predetermined distance from the first bend 305. A tapered, flat blade 309 extends from the shank 110a at the second bend 307. The tapered, flat blade 309 may be tapered in lateral width LW so that the flat blade lateral width LW increases as it extends away from the second bend 307 of the shank 110a.

The flat blade 309 may taper in thickness T so that the flat blade thickness T decreases as it extends away from the second bend 307 of the shank 110a. The flat blade 309 terminates in a hook which is formed by a hook bend 311 that creates a folded over extension 313 of the flat blade 309. As most clearly shown in FIG. 3, the molding removal tool 105a is capable of grabbing onto a window molding WM with the hooked flat blade 309 and removing the window molding WM from a window frame WF when guided by a user holding the handle 108a.

The lateral width LW of the hook is relatively wide, being between about ¼″ and ¾, in order to provide enough purchase for pulling the molding without tearing or damaging the molding. The bends or offset in the shank 110a leave the bight 311 of the hook substantially aligned with an axis extending coaxially through the center of the handle 108a so that the hook can be maneuvered beneath the molding and pulled along the axis of the handle 108a to remove the molding WM from the window frame WF.

It is to be understood that the present invention is not limited to the embodiments described above, but encompasses any and all embodiments within the scope of the following claims.

I claim:

1. A belt molding removal tool, comprising:
a handle grip; and
a rigid shank extending from the handle grip, the shank terminating in a flat blade hook.

2. The belt molding removal tool according to claim 1, wherein said shank comprises a straight shank.

3. The belt removal tool according to claim 1, wherein said shank has a pair of complementary bends formed therein, said hook being substantially in line with a longitudinal axis of said handle grip.

4. The belt removal tool according to claim 1, wherein the handle grip is a substantially cylindrical body that can fit in a user's palm.

5. The belt molding removal tool according to claim 1, wherein said shank has a longitudinal dimension that is substantially greater than its lateral dimension.

6. The belt molding removal tool according to claim 1, wherein said blade has a lateral dimension at least as wide as the shank lateral dimension, and is relatively wide, being between ¼ and ¾ wide.

7. The belt molding removal tool according to claim 1, wherein said blade hook is substantially U-shaped, forming a 180° bend, so that the blade is substantially parallel to the shank thereby causing the blade to be aimed towards the handle.

8. The belt molding removal tool according to claim 1, wherein said flat blade hook is tapered in lateral width.

9. The belt molding removal tool according to claim 1, wherein said flat blade hook is tapered in thickness.
